(19) United States
(12) Patent Application Publication
(10) Pub. No.: US 2008/0293019 A1
(43) Pub. Date: Nov. 27, 2008

(54) Money Storage Device with Separately Interactive Virtual Teller

(76) Inventors: Christopher P. Dooley, New Canaan, CT (US); Paul S. Nielsen, Saratoga Springs, NY (US); Loren Taylor, Chatham, NJ (US)

Correspondence Address: Michael G. Crilly, Esquire;Law Offices of Michael Crilly, 104 South York Road, Hatboro, PA, 19040, US

(21) Appl. No.: 12/125,491

(22) Filed: May 22, 2008

Related U.S. Application Data
(60) Provisional application No. 60/931,485, filed on May 22, 2007.

(51) Int. Cl. G09B 19/18

(52) U.S. Cl. 434/107

(57) ABSTRACT

A personal savings bank, for use by children, which is attachable to a computer as a peripheral device and simulates interactions with a teller as paper money and coins are deposited into and withdrawn from the device is described. The invention includes a money storage peripheral, a communications system, and software executed by a computer adjacent to and separate from the money storage device. The money storage peripheral is attached to the computer via a wire or wireless link. The software program controls a teller displayed on the computer which interacts with a child in response to cues from the money storage peripheral. The teller could include a real person or an animated character who speaks, commands, and responds to a child during use of the money storage peripheral. In some embodiments, the virtual teller projects the future value of an account, develops a saving plan, displays money-related references, and/or enables a child to play a game after deposit of a coin or paper money into the money storage peripheral.

### CROSS REFERENCE TO RELATED APPLICATIONS

This application is based upon and claims priority under 35 U.S.C. § 119(e) from U.S. Provisional Application No. 60/931,485 filed May 22, 2007, entitled Money Storage Device with Virtual Teller, the contents of which are hereby incorporated in their entirety by reference thereto.

### FEDERALLY SPONSORED RESEARCH AND DEVELOPMENT

None.

### BACKGROUND OF THE INVENTION

1. Field of the Invention

The present invention generally relates to a device facilitating savings and management of money. Specifically, the invention is a personal savings bank for children that is attachable to a computer as a peripheral device and simulates interactions with a teller as paper currency and coins are deposited into and withdrawn from the device.

2. Background

Most adults in the United States have a poor track record pertaining to the saving and management of money. However, their children as a group are better savers and managers, if properly trained to understand the value of money, how money works, and how the saving of money facilitates the purchase of things they want and need.

Presently known personal savings banks, otherwise referred to as piggy banks, are of limited utility and educational value to children with regard to the saving and management of money. Several examples are provided below.

Rogers, U.S. Pat. No. 6,896,573, describes a personal novelty bank including a microprocessor that senses when money is added to or removed from the device. The microprocessor moves an animated mechanical device attached to the bank and broadcasts selected phrases therefrom.

Woods, U.S. Pat. No. 6,454,570, describes a piggy bank directly connected to the internet. The device tracks deposits and withdrawals of funds which are retained within the device. Transactions are communicated to a bank accessed via the internet to track the total funds within the piggy bank. Account balance and transactional information are reported in a statement mailed to a user.

Vetter, U.S. Pat. No. 5,716,211, describes a personal savings bank including separate storage locations for category specific savings. A microprocessor residing within the device calculates and displays the total amount in each investment category and projects future values.

Gotman et al., U.S. Pat. No. 4,811,828, describes a personal savings bank with a plurality of coins slots which are selectively opened and closed by a user.

Bush, U.S. Pat. No. 4,673,368, describes a personal coin bank having a mechanism which identifies the value of each coin inserted into the device based on its diameter.

As is readily apparent from the discussions above, the related arts do not include a personal savings bank for a child which is attachable to a computer as a peripheral and replicates a money-related transaction typically encountered at a bank.

Therefore, what is required is a personal savings bank for children that is attachable to a computer as a peripheral device and simulates interactions with a teller as paper currency and coins are deposited into and withdrawn from the device.

### SUMMARY OF THE INVENTION

An object of the present invention is to provide a personal savings bank, for use by children, which is attachable to a computer as a peripheral device and simulates interactions with a teller as paper currency and coins are deposited into and withdrawn from the device.

The present invention includes a money storage peripheral capable of receiving and storing money and having a communications port for direct connection to a locally-based computer via wire or wireless means. The money storage peripheral includes receptacles for coins and paper currency with real-time identification and counting functionality, functional keypad, and LCD or LED display. The computer executes a software program allowing a child to establish accounts, to track and project savings, and to review references including educational materials pertaining to money management and the like. The software also prompts a child, via visual and sound effects, during a deposit or withdrawal transaction. Furthermore, the software communicates with a child so that he or she knows when savings are not on track and when a savings goal is achieved.

The present invention allows a child to quickly and easily establish a savings account. The software package further allows a child to plan his or her finances with little or no adult supervision. The software program provides visual and audio cues which enable a child to watch his or her money grow and to learn how to be a responsible saver and prudent spender. For example, sound effects, rewards, and animation could include a money tree, a pile of money that grows, or animations of a child being driven around in a limousine, talking on a cellular telephone, playing on a computer, at a vacation destination, or playing with a pet. Goals could be personalized with visual presentations of the items for which the child is saving, examples including, but not limited to, a television, a cellular phone, an MP3 player, a vacation, a pet, or the like. In yet other embodiments, the child could insert pictures of herself, family members, friends, and pets into a theme-related background, one example being the lifestyles of the rich and famous, which is displayed on the computer and printable therefrom. In still other embodiments, funny characters and/or humorous stories, graphics, games, and sounds may prompt a child and encourage, reinforce, and reward good savings and money management behavior.

Several advantages are offered by the present invention. The graphical interface of the present invention simulates real-time, bank-related transactions, thus allowing a child to perform otherwise complex tasks in an easy to use, friendly, and understandable format. The graphical interface teaches and reinforces skills required for successful money management in a fun, non-threatening, and engaging format.

### REFERENCE NUMERALS

1 Money storage peripheral
2 Wire-based link
3 Computer
4 Wireless link
5 Housing
6 Coin receptacle
7 Paper Receptacle
8 Display
9 Keypad
10 Storage bin
11 Door
12 Pad
13 Connector port
14 Keypad assembly
15 Opening
16 Key
17 Bushing
18 Fastener
19 Printed circuit board
20 Opening
21 Castor
22 Slot
23 Spring
24 Arm
25 Circuit board
26 First contact
27 Second contact
28 Cable
29 Opening
30 Coin
31 Housing
32 Chute
33 Chute
34 Paper currency
35 Hinge assembly
36 Lock mechanism
37 Handle
38 Motor
39 Roller
40 Microcontroller unit
41 Power Supply
42 Wire communications system
43 Wireless communications system
44 Coin receptacle device
45 Currency receptacle device
46 Display
47 Keypad
48 Display element
49 Virtual teller
50 Background
51 Adhesive
52 Zebra strip
53 Integrated circuit
54 Panel
100 Software
101-161 Step
201 Startup screen
202 Input field
203 Navigation bar
204 Account summary screen
205 Account summary field
206 Selection field
207 Deposit screen
208 Input field
209 Withdrawal screen
210 Input field
211 Planning screen
212 Selection field
213 Report screen
214 Plot field
215 Game screen
216 Game icon
217 Profile screen
218 Input field

### BRIEF DESCRIPTION OF THE INVENTION

The invention will now be described in more detail, by way of example only, with reference to the accompanying drawings, in which:

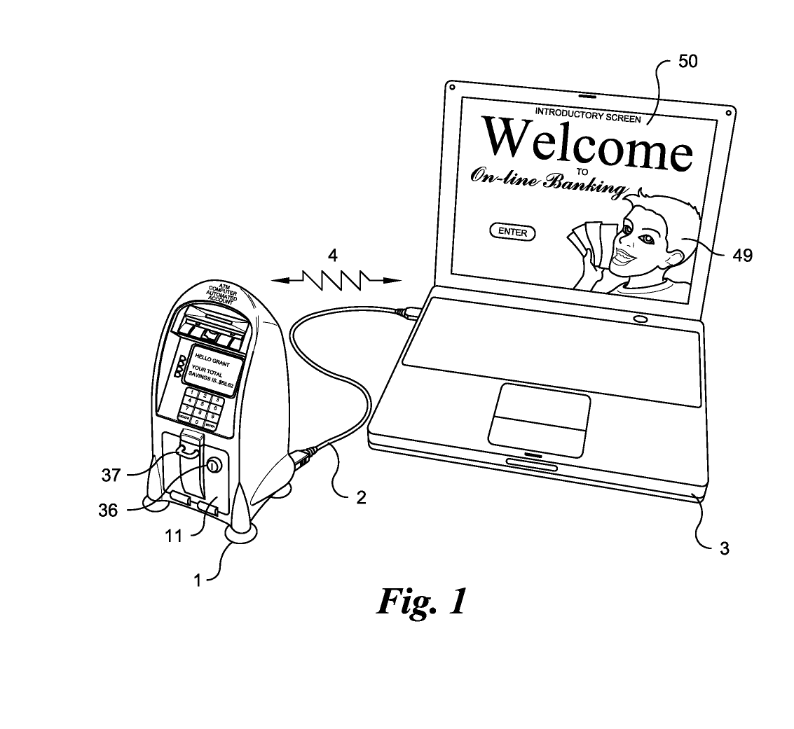

FIG. 1 is a perspective view illustrating an exemplary money storage peripheral communicating with a computer via wire and wireless means in accordance with an embodiment of the present invention.

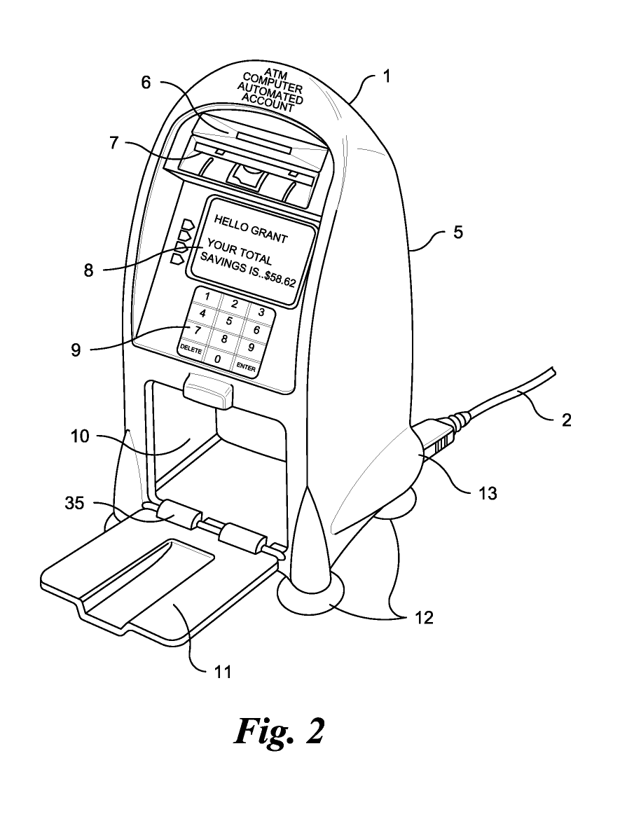

FIG. 2 is a perspective view illustrating an exemplary money storage peripheral in accordance with an embodiment of the present invention.

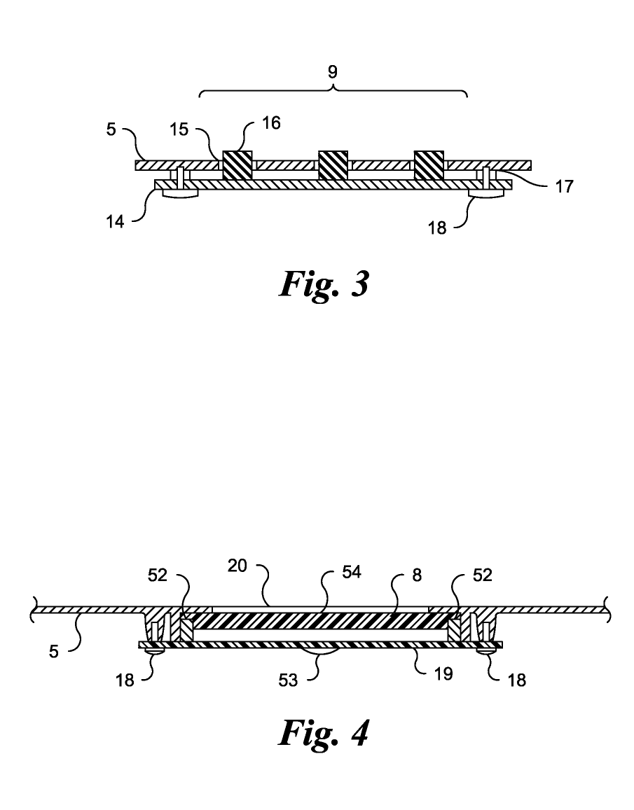

FIG. 3 is a cross-sectional view illustrating attachment of a keypad to a housing along a money storage peripheral in accordance with an embodiment of the present invention.

FIG. 4 is a cross-sectional view illustrating attachment of a display panel to a housing along a money storage peripheral in accordance with an embodiment of the present invention.

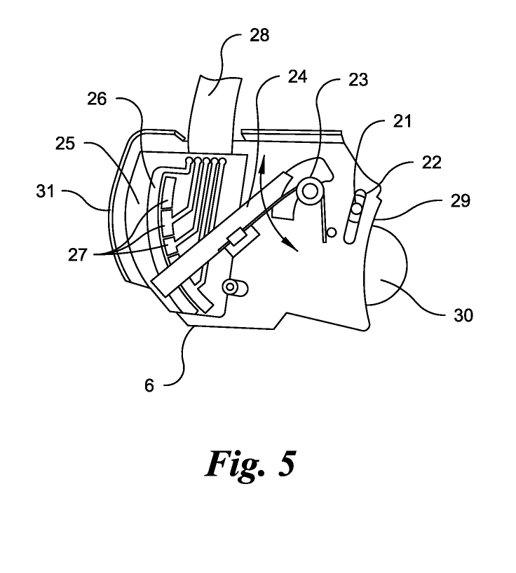

FIG. 5 is a side elevation view illustrating a coin receptacle in accordance with an embodiment of the present invention.

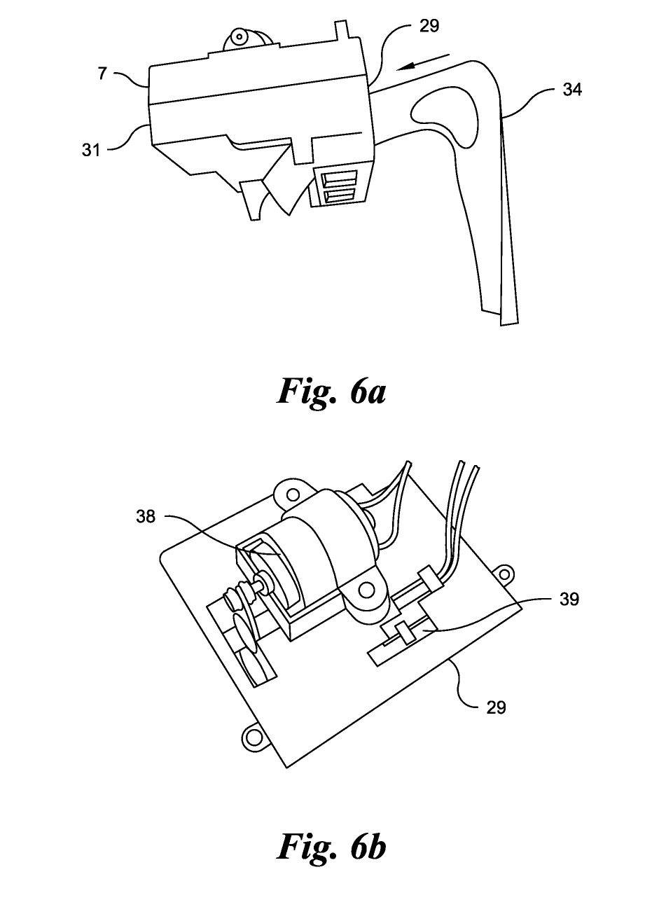

FIG. 6a is a side elevation view illustrating a paper money receptacle in accordance with an embodiment of the present invention.

FIG. 6b is a top elevation view of the paper money receptacle from FIG. 6a.

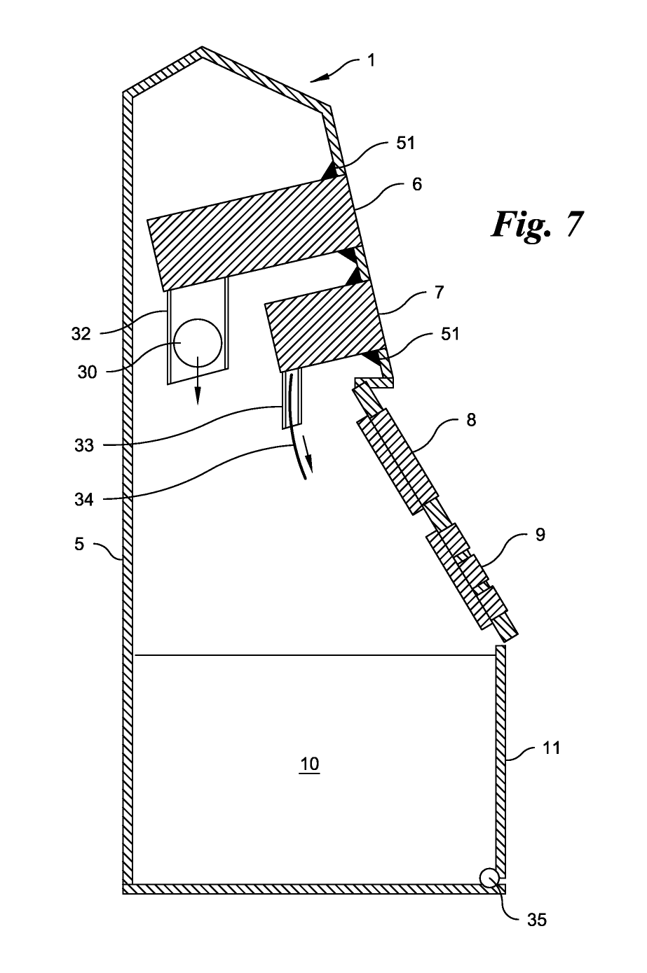

FIG. 7 is a partial section view illustrating a money storage peripheral in accordance with an embodiment of the present invention.

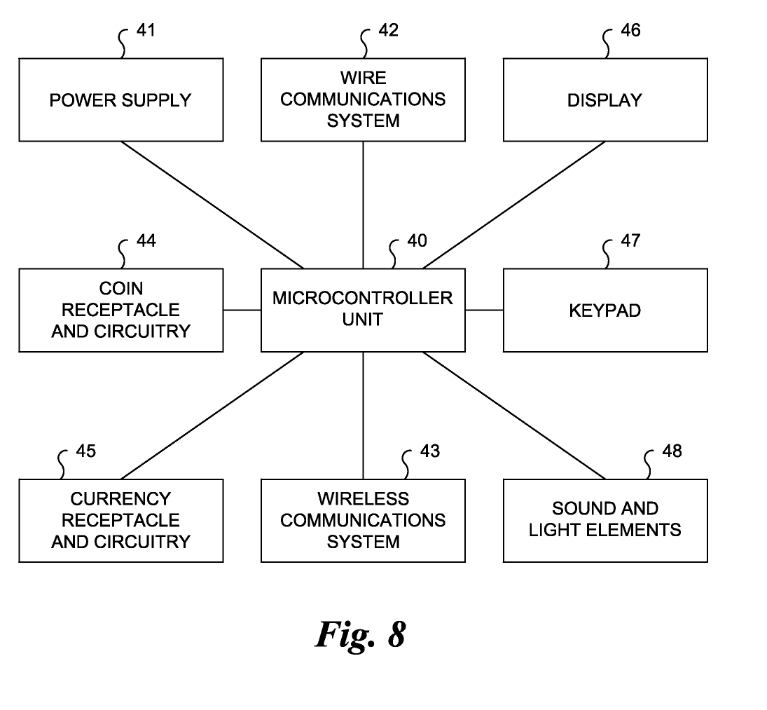

FIG. 8 is a block diagram illustrating a money storage peripheral in accordance with an embodiment of the present invention.

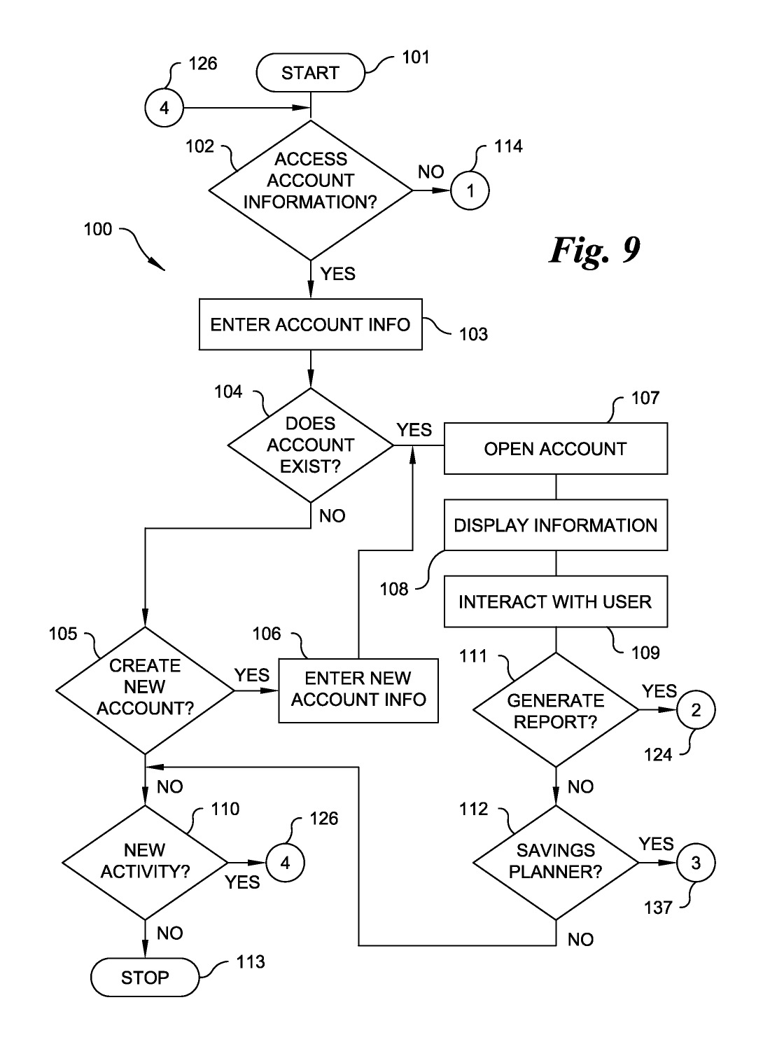

FIG. 9 is an exemplary flowchart illustrating an account access routine from the virtual teller software in accordance with an embodiment of the present invention.

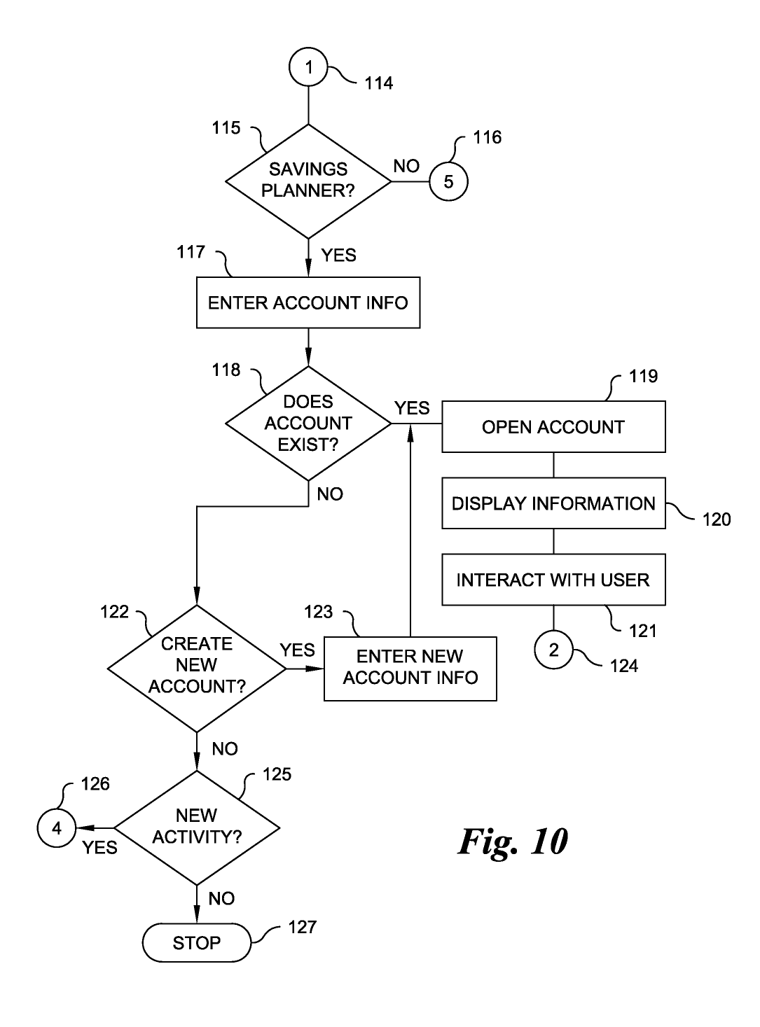

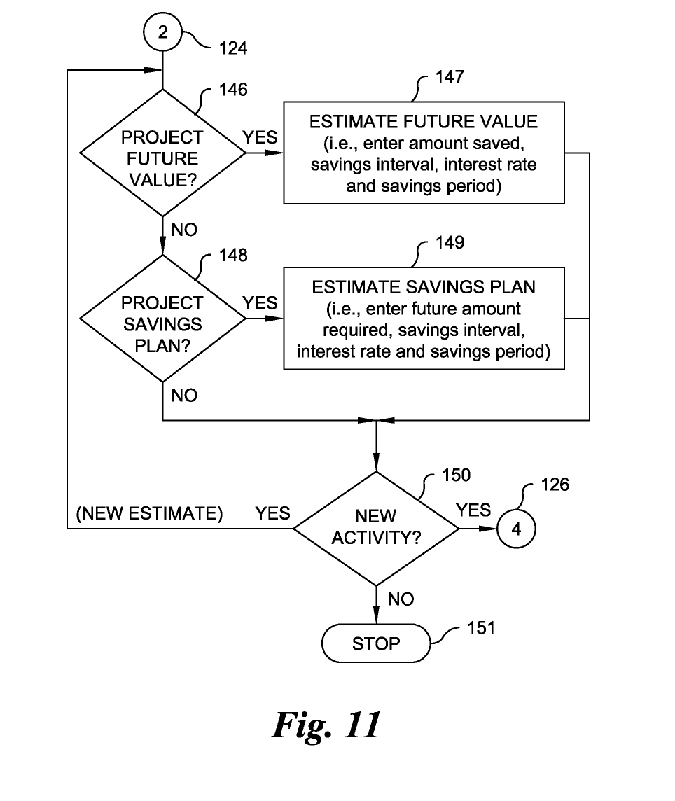

FIGS. 10 and 11 are exemplary flowcharts illustrating a savings planner routine from the virtual teller software in accordance with an embodiment of the present invention.

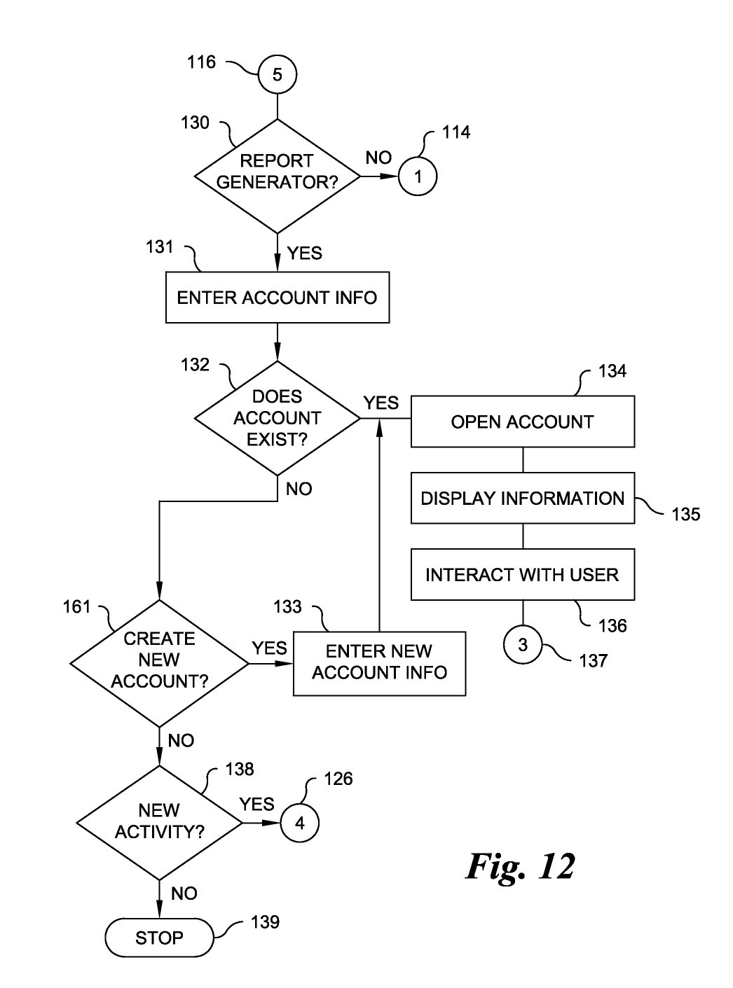

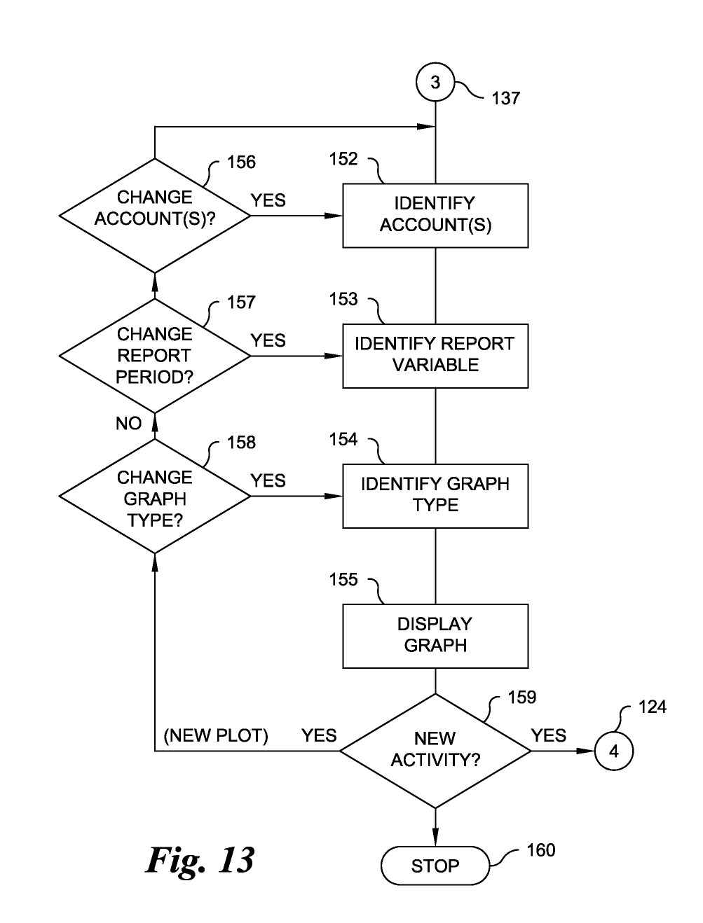

FIGS. 12 and 13 are exemplary flowcharts illustrating a report generation routine from the virtual teller software in accordance with an embodiment of the present invention.

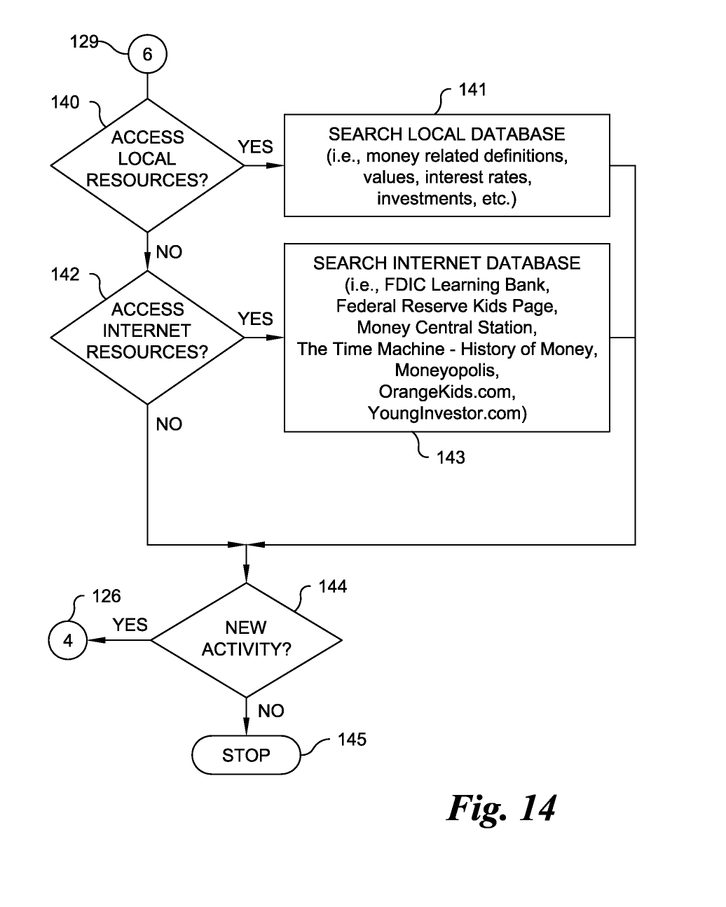

FIG. 14 is an exemplary flowchart illustrating a reference routine from the virtual teller software in accordance with an embodiment of the present invention.

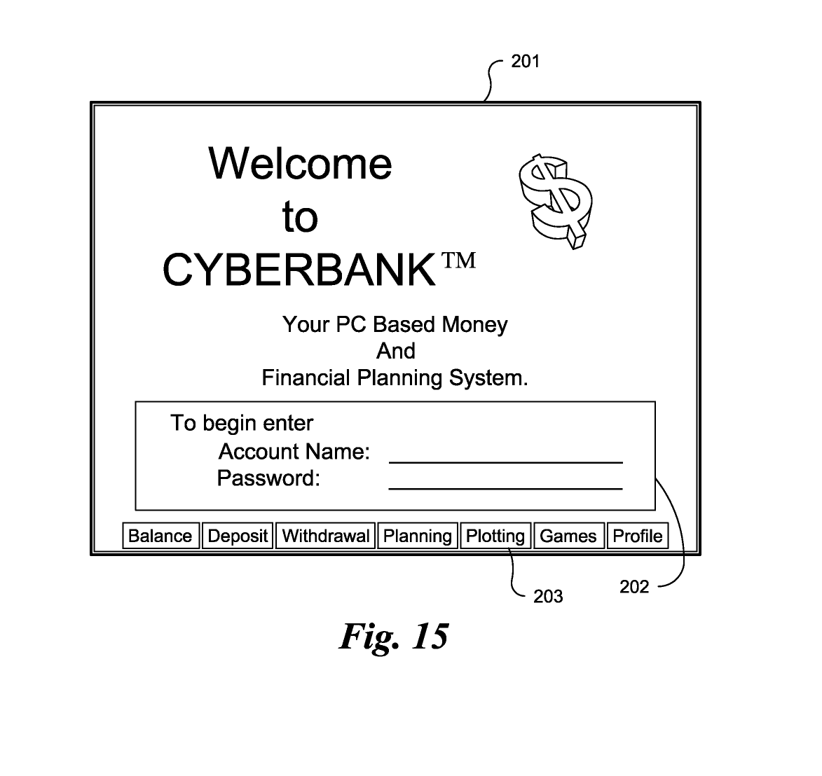

FIG. 15 is an exemplary display illustrating a startup screen displayed by a computer communicating locally with a money storage peripheral in accordance with an embodiment of the present invention.

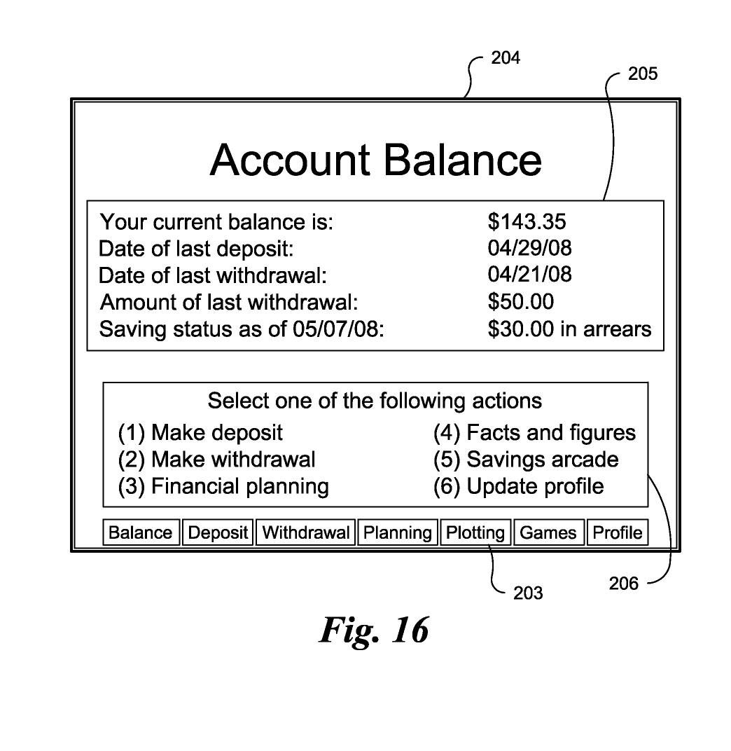

FIG. 16 is an exemplary display illustrating an account balance screen displayed by a computer communicating locally with a money storage peripheral in accordance with an embodiment of the present invention.

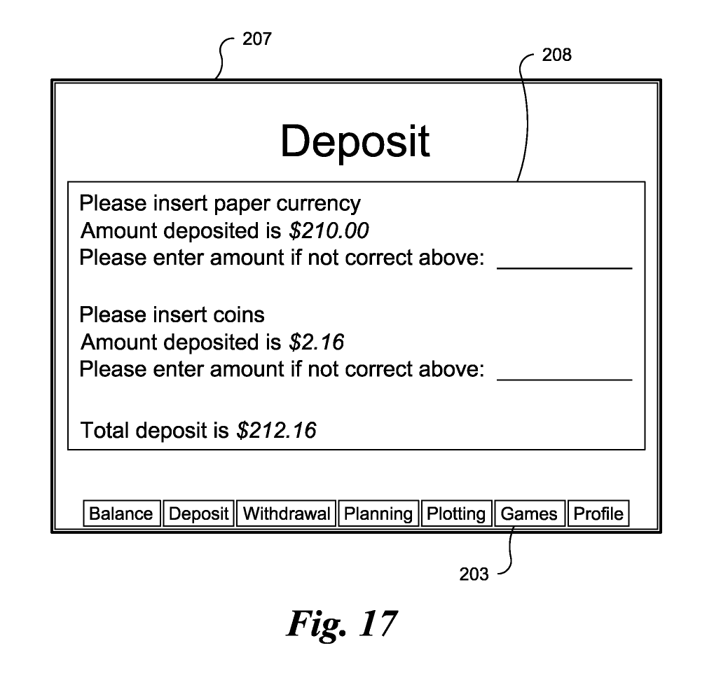

FIG. 17 is an exemplary display illustrating a deposit screen displayed by a computer communicating locally with a money storage peripheral in accordance with an embodiment of the present invention.

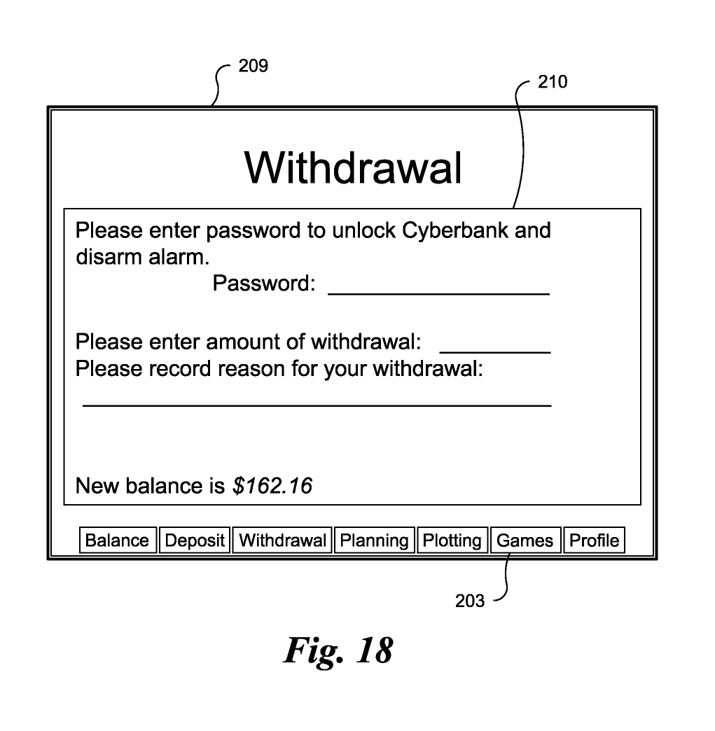

FIG. 18 is an exemplary display illustrating a withdrawal screen displayed by a computer communicating locally with a money storage peripheral in accordance with an embodiment of the present invention.

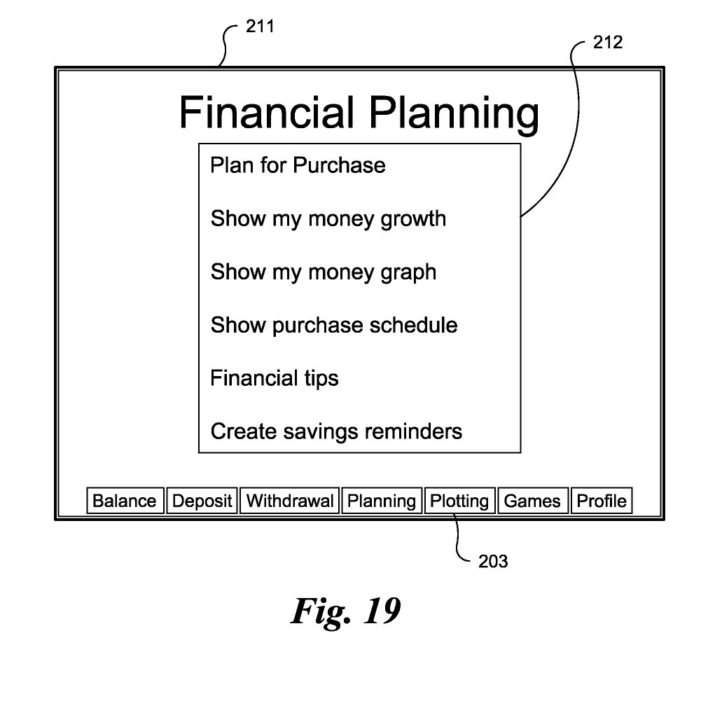

FIG. 19 is an exemplary display illustrating a financial planning screen displayed by a computer communicating locally with a money storage peripheral in accordance with an embodiment of the present invention.

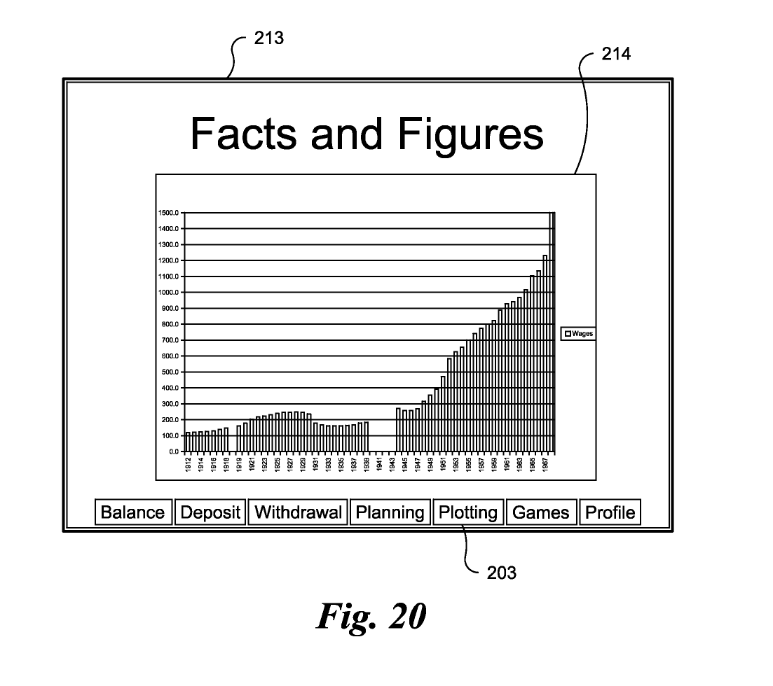

FIG. 20 is an exemplary display illustrating a report screen displayed by a computer communicating locally with a money storage peripheral in accordance with an embodiment of the present invention.

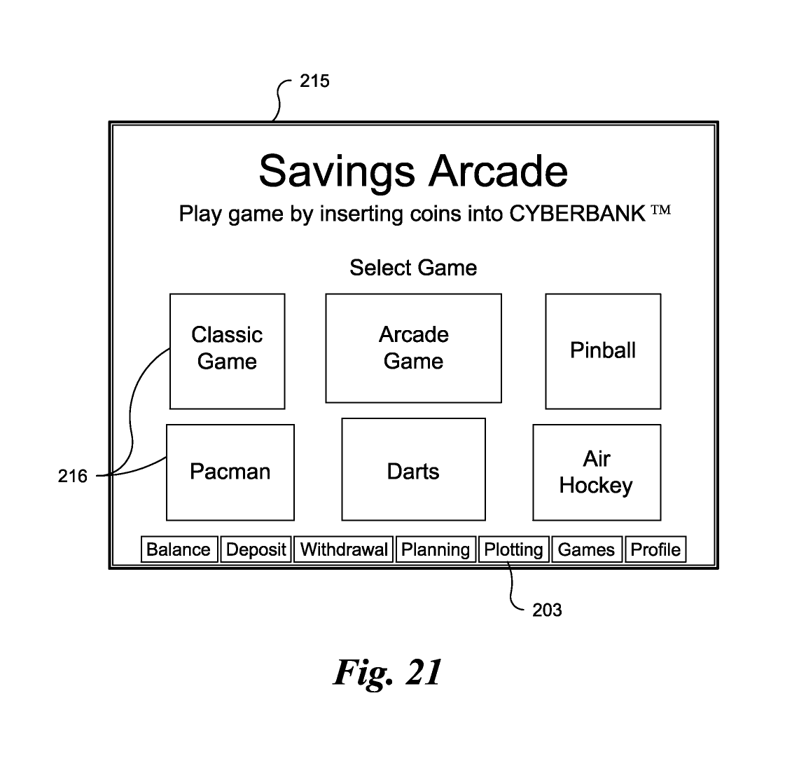

FIG. 21 is an exemplary display illustrating a games screen displayed by a computer communicating locally with a money storage peripheral in accordance with an embodiment of the present invention.

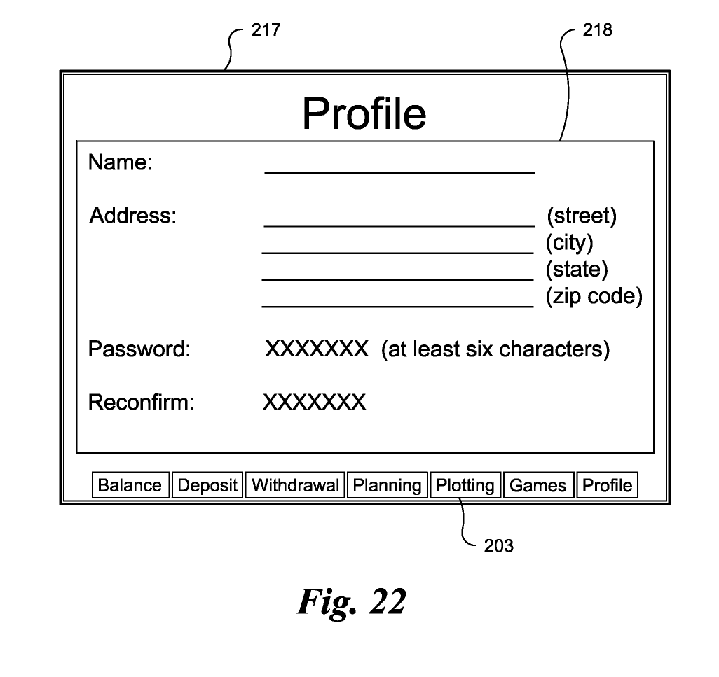

FIG. 22 is an exemplary display illustrating a profile screen displayed by a computer communicating locally with a money storage peripheral in accordance with an embodiment of the present invention.

### DETAILED DESCRIPTION

Referring now to FIG. 1, one embodiment of the present invention is shown including a money storage peripheral 1 in communications with a computer 3 via either a wire-based link 2 or wireless link 4. The computer 3 is a desktop or laptop device which resides adjacent to but separate from the money storage peripheral 1. The wire-based link could include a USB cable, serial cable, parallel cable or the like which is directly connected to complimentary ports mutually disposed on the money storage peripheral 1 and computer 3. The wireless link 4 could include transmitter/receiver devices residing within or attached physically and electrically to the computer 3 and money storage peripheral 1, examples including, but not limited to, a radio frequency (RF) based system, WIFI based system, optical system (IRdA), or a BLUETOOTH enabled system. Additional information pertaining to BLUETOOTH specifications is available at www.bluetooth.com.

Software described herein is executed by the computer 3 which displays information both visually and audibly to a user via a virtual teller 49 and optional background 50. The virtual teller 49 could include a real person, one example being a likeness or image of the user, or an animated character who talks to the user to facilitate proper usage of the money storage peripheral 1. The virtual teller 49 is preferred to replicate the facial dynamics, examples including the movement of lips, eyelids, cheeks, eyes, nose, chin, ears, hair, throat, forehead, and/or head, consistent with speech. In some embodiments, functionality of the virtual teller 49 is prompted by the user's physical interaction with the money storage peripheral 1. The background 50 could include a bank setting or other scene or theme chosen or created by the user.

The wire-based link 2 and wireless link 4 facilitate exchange of information, data, commands, and signals between the money storage peripheral 1 and computer 3. Software described herein is executed by the computer 3 so as to receive information, data, commands, and signals from and to send information, data, commands, and signals to the money storage peripheral 1. Exemplary communications could include, but not limited to, the values of paper currency and/or coins deposited into and/or withdrawn from the money storage peripheral 1, a password or personal identification number (PIN), account identification information, access commands which lock and unlock the money storage peripheral 1, and/or commands which arm and disarm an alarm system within the money storage peripheral 1.

Referring now to FIGS. 2 and 7, the money storage peripheral 1 is preferred to be a miniature, functional teller-like device. In preferred embodiments, the money storage peripheral 1 is composed of a molded plastic housing 5 and includes a functional display 8 (examples including but not limited to an LED or LCD screen), a functional keypad 9 (either numeric or alphanumeric), paper receptacle 7, coin receptacle 6, and a storage bin 10 with operable door 11. Keypad 9 and display 8 are preferred to be bonded or fastened to the inside of the housing 5.

The door 11 could include at least one hinge assembly 35 disposed between one edge of the door 11 and the housing 5 so as to facilitate access to the storage bin 10. The money storage peripheral 1 could also include two or more pads 12 composed of a plastic or soft rubber which support the device along a mounting surface. In other embodiments, one or more connector ports 13 could be provided along the housing 5 for connectivity to USB, serial, parallel, or other communications cables commonly used with a computer 3.

Referring now to FIG. 3, a keypad assembly 14, including a plurality of keys 16 attached to a circuit board or the like, could be positioned along the housing 5 and separated therefrom via bushings 17. A fastener 18 passes through the keypad assembly 14 and bushing 17 and is thereafter secured to the housing 5. Openings 15 are positioned along the housing 5 and dimensioned so as to allow individual keys 16 to extend beyond the housing 5.

Referring now to FIG. 4, the display 8 could include an LCD or LED panel 54, zebra strips 52, a printed circuit board 19, and an integrated circuit 53. The panel 54 is aligned with the zebra strips 52 and thereafter fastened to the printed circuit board 19 via screws or the like to compress the zebra strips 52 between the printed circuit board 19 and panel 54. Zebra strips 52 function as connectors between tracings along the printed circuit board 19 and conduits along the panel 54. The integrated circuit 53 is bonded and electrically connected to the printed circuit board 19. The integrated circuit 53 controls the ON and OFF functionality of pixels within the panel 54 via tracings within the printed circuit board 19 and zebra strips 52. Fasteners 18 pass through the printed circuit board 19 and are secured to the housing 5. An opening 20 is located along the housing 5 and dimensioned so that the display 8 is visible through the housing 5. In some embodiments, a transparent cover or lens could be positioned in the opening 20 to protect and/or to improve image quality of the display 8.

In some embodiments, the display 8 could visually communicate information to the user including account related data received from the computer 3 or entered by the user via the keypad 9. In other embodiments, entries from the keypad 9, examples being the value of paper bills or coins deposited into or withdrawn from the money storage peripheral 1, are communicated via the wire or wireless means described herein to the computer 3 for processing and storage. In preferred embodiments, coin and paper receptacles 6, 7 have real-time counting functionality and data therefrom is communicated to the computer 3 for processing and storage.

In preferred embodiments, audio communications from the virtual teller 49 are broadcasted via the sound card and speakers residing within the computer 3. In other embodiments, optional speakers could be provided in or attached to the money storage peripheral 1 to deliver commands and responses from the virtual teller 49 to the user. For example, the virtual teller 49 could greet the user and provide one or more prompts which enable a user to complete a banking transaction, examples including deposits, withdrawals, and account balance summaries. Also, the virtual teller 49 could audibly request access information from the user, examples including but not limited to account name and/or number, password, and PIN.

In other embodiments, the money storage peripheral 1 could include a functional or faux finger print scanner to properly identify the user. The money storage peripheral 1 is preferred to prompt the user to enter a password, PIN, or other verifiable information when a faux scanner is used.

Referring now to FIG. 5, an exemplary coin receptacle 6 is described including a molded plastic housing 31. The housing 31 includes an opening 29 which is sufficiently long and wide to accept a wide variety of coins 30. A slot 22 is located adjacent to the opening 29 and a castor 21 is slidably disposed therein. The castor 31 contacts an arm 24 which is rotated when a coin 30 is inserted into the opening 29 and interacts with the castor 21. A spring 23 contacts the arm 24 and housing 31 so as to bias the starting position of the castor 21 along the slot 22 and within the opening 29. A circuit board 25 is located adjacent to one end of the arm 24, parallel thereto, and attached to the housing 31. The circuit board 25 includes a first contact 26 and a plurality of second contacts 27 in a parallel arrangement. First and second contacts 26, 27 are electrically connected to a ribbon-type cable 28. In operation, the insertion of a coin 30 into the opening 29 causes the castor 21 to move along the slot 22, thus sweeping the arm 24 along the first and second contacts 26, 27 so as to complete the circuit corresponding to the value of the coin 30. After insertion, a coin 30 passes through the coin receptacle 6 and is directed into the storage bin 10, as represented in FIG. 7.

Referring now to FIGS. 6a and 6b, an exemplary paper receptacle 7 is described including at least a motor 38 communicating with a roller 39, both residing within a molded plastic housing 31. An opening 29 at one end allows for the insertion of paper currency 34. In preferred embodiments, the insertion of paper currency 34 into the opening 29 causes contact with a switch or the like which activates the motor 38 and roller 39 so that the paper currency 34 is fed into and through the paper receptacle 7 and thereafter directed into a storage bin 10 like that represented in FIG. 7. In some embodiments, the paper receptacle 7 could automatically identify the value of the paper money via an optical or magnetic sensor which reads or detectors an identifier along or embedded within the paper currency 34.

In other embodiments, the user could enter the value of coins and paper money deposited by an individual via either the keypad 9 or a keyboard attached to the computer 3. In still other embodiments, the user could be required to manually enter the value of the deposit as described herein which is thereafter confirmed by at least one sensor. It yet other embodiments, the coin and paper receptacles 6, 7 could dispense paper and coin money, respectively, during a withdrawal transaction via commands communicated from either the keypad 9 or computer 3.

In preferred embodiments, the storage bin 10 is secured to prevent unauthorized entry. Referring again to FIG. 1, the door 11 is shown including a lock mechanism 36 and an optional handle 37 molded thereon or mechanically attached thereto. The lock mechanism 36 could include a mechanical device which is key operable and capable of locking and unlocking the door 11 with respect to the housing 5. The lock mechanism 36 could also include a mechanical device whereby the user enters an access code via the keypad 9 or computer 3 so as to cause a motor to turn a gear train to lock and/or unlock the door 11. In yet other embodiments, the lock mechanism 36 could be an electrically operable device with audio alarm and flashing lights and/or motion or vibrations sensors to prevent someone from physically entering or moving the money storage peripheral 1. In still other embodiments, the money storage peripheral 1 could include a lockout feature which disables the device when unauthorized access is attempted. The lockout feature could be controllable from the keypad 9 and/or computer 3.

Referring again to FIG. 7, the coin and paper receptacles 6, 7 could be bonded to the housing 5 via an adhesive 51 so that each is flush mounted with respect to the exterior of the money storage peripheral 1. The coin and paper receptacles 6, 7 could each include a chute 32 and 33, respectively, which directs a coin 30 or paper currency 34 via gravity into the storage bin 10 at the bottom of the money storage peripheral 1.

Referring now to FIG. 8, a block diagram is provided for one possible embodiment of the money storage peripheral 1. This diagram is not meant to be exhaustive of the electrical components used within the present invention, but rather is merely illustrative to assist in describing the hardware utilized in the manner described herein.

A microcontroller unit 40 is disposed within and physically attached to the money storage peripheral 1. In preferred embodiments, the microcontroller unit 40 controls functionality of and between one or more devices within the money storage peripheral 1. Accordingly, the microcontroller unit 40 could include a processor, memory, and storage device or the like disposed along to a circuit board. A power supply 41, one example being a battery, could be electrically attached to the microcontroller unit 40 so as to allow for the communication of power to other devices within the money storage peripheral 1 based on need and functionality. The display 46 and keypad 47 are electrically attached to the microcontroller unit 40 so that the display 46 shows the numeric or alphanumeric values entered by a user via the keypad 47. The coin and paper receptacle devices 44, 45 are likewise electrically attached to the microcontroller unit 40 which tracks and stores data pertaining to funds held within, deposited into, and withdrawn from the money storage peripheral 1. In some embodiments, the display 46 could show the value of individual coins and paper money and/or their total entered into or withdrawn from the money storage peripheral 1 in real time. Also, the keypad 47 could be used to enter the amount to be withdrawn which is thereafter communicated from the microcontroller unit 40 to the respective coin and paper receptacle devices 44, 45.

The microcontroller unit 40 is electrically connected to either a wire communications system 42 and/or wireless communication system 43 described herein. The wire and wireless communication systems 42, 43 facilitate communication of information, data, commands, and signals between the computer 3 and microcontroller unit 40 and/or other devices within the money storage peripheral 1. In yet other embodiments, display elements 48, example including light and sound generating devices residing on or attached to the money storage peripheral 1, are electrically attached to the microcontroller unit 40. Display elements 48 could serve a variety of purposes including, but not limited to, entertainment, educational, and security.

The virtual teller 50 is implemented by the software 100 which resides on and is executed by the computer 3. In some embodiments, the software 100 could query the money storage peripheral 1 when first launched to determine its operational status. Execution of the software 100 could be terminated when the money storage peripheral 1 is non-functional or not communicating with the computer 3, so as to prevent usage of the software 100 separate from the money storage peripheral 1.

The software 100 described in FIGS. 9-14 provide for one possible embodiment of the virtual teller 50. Flowcharts not meant to be exhaustive of the appearance and functionality of the present invention, but rather are merely illustrative to assist in describing aspects of the software 100 and its function in the manner described herein.

The software 100 controls and directs functionality and interoperability between the money storage peripheral 1 and the computer 3. The software 100 further provides additional features including savings planner, money manager, and financial report creator. The savings planner could enable the user to schedule saving times and amounts with visual and/or audio reminders. The money manager could allow the user to access and view account balances and project future values based on current saving trends. The financial report creator could allow the user to view and print reports pertaining to accounts, saving trends, saving goals, and the like. The software 100 could also facilitate a link to local and online reference materials of particular interest to young investors.

In one embodiment, the software 100 includes a series of screens displayed by the computer 3 which are intuitive and highly entreating. Screens are easy to read and understand and could include voice recitations of the some or all of the contents displayed on the screen. Screens could be displayed to remind a user to make deposits so as to ensure compliance with saving plans and goals. In some embodiments, the user is rewarded via visual and audio cues when savings goals are on track and/or completed. Calendar-type screens are likewise displayable to enable a user to track savings goals and to print paper copies for placement on a wall, corkboard, and the like.

Cues could include a variety of features. For example, in some embodiments lights or sound could communicate to the user via elements attached to the money storage peripheral 1. In other embodiments, fun animation could be displayed on the computer 1, examples including but not limited to a money tree or a pile of money that grows, a thermometer with reading that increases with savings, or animations of a child being driven around in a limousine, talking on a cellular telephone, playing on a computer, lounging at a vacation destination, or playing with a pet. Goals can be personalized with visual representations of the items for which the child is saving, examples including but not limited to a television, a phone, an MP3 player, a vacation, a pet, or the like. Furthermore, accounts may be visually represented by icons which correspond to the item for which the savings or plan corresponds. In yet other embodiments, a child may insert pictures of herself and others, via software compatible with WINDOWS® or other operating systems, for placement into theme-based backgrounds which are displayed on the computer 3 and printable therefrom. In some embodiments, animations could include licensed characters or famous persons who encourage the user to save more or praise the user when a goal is achieved.

The virtual teller 49 is displayed on the computer 3 and controlled by the software 100. The virtual teller 49 could include the image of a real person or animated character who talks and moves along the display screen of the computer 3. The virtual teller 49 could entertain and educate the user on financial issues, including savings, savings growth, money related terms and definitions understandable to a young investor, and financial planning. In some embodiments, the virtual teller 49 is one or more animated characters which verbally or visually communicate with the user to ensure the attention and concentration to perform and complete a variety of banking-related transactions.

In preferred embodiments, the virtual teller 49 interacts with the functionality of the money storage peripheral 1. For example, the total value of paper currency and/or coins deposited into the money storage peripheral 1 could be calculated by either the money storage peripheral 1 or software 100 and audibly communicated to the user via the speakers and sound card in the computer 3. It is likewise possible for the virtual teller 49 to issue a series of commands which enable deposit or withdrawal of funds from the money storage peripheral 1. The virtual teller 49 could be implemented using one or more programming languages which facilitate animated visual and audio displays on a personal computer or the like.

In one form of the present invention, the software 100 could include an account access routine, a savings planner routine, a report generator routine, and a reference routine displayed as screens on the computer 3. Routines and screens could be implemented via one or more programming languages. Screens could include all standard features of a menu or screen driven application, including but not limited to pull downs, popups, text fields, buttons, and other animated and static graphic-based elements, and also include the execution of routines, data input, data analysis, and data output. Furthermore, the virtual teller 49 displayed on the computer 3 by the software 100 could include a real person or animated character, displayed concurrently with the screens in FIGS. 15-22, which talks to the user to explain, direct, and manage activities thereof. In some embodiments, the person or character could replicate facial and mouth movements. It is also possible for the virtual teller 49 to visually and audibly communicate portions or the entire content associated with the steps shown in FIGS. 9-14. While FIGS. 9-14 represent one possible embodiment of the present invention, other embodiments and variations thereof are contemplated. The software 100 opens, closes, creates, and updates files containing information required for execution of the software 100 and pertaining to accounts and plans created by a user.

Referring now to FIG. 9, an exemplary embodiment of the account access routine is provided. A variety of audio and visual cues as described herein are activated by the software 100, as appropriate, as the user accesses new and existing accounts and related routines.

The virtual teller 49 could be displayed by the user in step 101 by selecting an icon displayed on the desktop or in a folder on the computer 3. Thereafter, the software 100 displays the virtual teller 49 including components, related programs, and data therefore. The user accesses account information by selecting an icon represented by step 102 which then displays an input field allowing the user to enter account identification information in step 103. Such information could include account name or number, password, and/or personal identification number (PIN). The software 100 determines whether the account exists in step 104. If the user does not wish to enter account information, the user could select to execute the saving planner routine described in FIGS. 10 and 11, as represented by the connector “1” 114.

If the identified account exists, account information is retrieved in step 107, displayed on or by the computer 3 in step 108, and thereafter interacted with the user in step 109. Interactions could include updating, supplementing, and/or viewing account information and savings data. The user could access the report routine in step 111 by selecting another icon displayed on the computer 3 or access the savings planner routine 112 by selecting yet another icon. Connectors “2” and “3” identified by reference numerals 124 and 137 correspond to flowcharts in FIGS. 11 and 13, respectively.

If the account does not exist, the user is queried to create a new account in step New account information is entered in step 106 and accessed in steps 107-109, 111, 112, 124, and 137, as described above; otherwise, the user is queried whether a new activity is to be performed in step 110 including return to the main screen as represented by the connector “4” 126 or termination of the virtual teller 49 in step 113 including the steps of closing all programs executed and files opened by the software 100.

Referring now to FIGS. 10 and 11, an exemplary embodiment of the savings routine is provided. A variety of audio and visual cues as described herein are activated by the software 100, as appropriate, as the user accesses features of the savings planner.

The user is queried to access the savings planner by selecting an icon represented by step 115 which then displays an input field allowing the user to enter account identification information in step 117. Such information could include filename, account name or number, password, and/or PIN. The virtual teller determines whether the identified account exists in step 118. If the user does not wish to enter account information, the user could select to execute the report generator routine as represented by the connector “5” 116.

If the account exists, account information is retrieved in step 119, displayed on or by the computer 3 in step 120, and thereafter interacted with the user in step 121. The user then could project future values or develop a saving plan, as represented by the connector “2” 124.

If the user selects to project future value in step 146, she could then be required to enter information for analysis. For example, the user could be required to enter the amount saved, savings interval, interest rate, and savings period as represented in step 147. Future value projections could be calculated by the software 100 and graphically displayed for review by the user.

If the user selects to develop a savings plan in step 148, she could then be required to enter information for analysis. For example, the user could be required to enter the future amount required, savings interval, interest rate, and savings period, as represented in step 149. A savings plan could be calculated by the software 100 and graphically displayed for review by the user.

Thereafter, the user is queried whether a new activity is desired in step 150. Choices could include a new projection or plan returning to step 146, a return to the main screen as represented by the connector “4” 126, or termination of the virtual teller 49 in step 151 including the steps of closing all programs executed by and files opened by the software 100.

If the account does not exist, the user is queried to create a new account in step 122. New account information is entered in step 123 and accessed in steps 119-121 and 146-151, as described above; otherwise, the user is queried whether a new activity should be performed in step 125 including return to the main screen as represented by the connector “4” 126 or termination of the virtual teller 49 in step 127 including the steps of closing all programs executed and files opened by the software 100.

Referring now to FIGS. 12 and 13, an exemplary embodiment of the report generator routine is shown and described. A variety of audio and visual cues as described herein are activated by the software 100, as appropriate, as the user accesses, views, and prints account information.

The user is queried to access the report generator by selecting an icon represented by step 130 which then displays an input field allowing the user to enter account identification information in step 131. Such information could include filename, account name or number, password, and/or PIN. If the user does not wish to enter account information, the user could return to the main screen as represented by the connector “1” 114.

Next, the virtual teller 49 determines whether the account exists in step 132. If the account exists, account information is retrieved in step 134, displayed on or by the computer 3 in step 135, and thereafter interacted with the user in step 136. The user then could prepare the report, as represented by the connector “3” 137.

A report is generated after the user identifies the account(s) in step 152, report variables in step 153, and graph type(s) in step 154, examples including but not limited to bar, line, pie, and text. The preparation of a report could require the software 100 to analyze data entered by the user. The report is thereafter displayed visually on the display of the computer 3 in step 155. The user could print the report to a printer or other peripheral device.

Thereafter, the user is queried whether a new activity is desired in step 159. Choices could include a new report including a change to the graph type in step 158, the report period in step 157, and/or account(s) in step 156, or return to the main screen as represented by the connector “4” 124, or termination of the virtual teller 49 in step 160 including the steps of closing all programs executed and files opened by the software 100.

If the account does not exist, the user is queried to create a new account in step 161. New account information is entered in step 133 and accessed in steps 134-136 and 152-160, as described above; otherwise, the user is queried whether a new activity is to be performed in step 138 including return to the main screen as represented by the connector “4” 126 or termination of the virtual teller 49 in step 139 including the steps of closing all programs executed by and files opened by the software 100.

Referring now to FIG. 14, an exemplary embodiment of a reference routine is shown and described. A variety of audio and visual cues as described herein are activated by the software 100, as appropriate, as the user accesses reference materials. For example, definitions could include a character or animated object which recites the definition of a term with examples. Unlike the other routines, the reference routine could be readily accessible from anywhere in the virtual teller 49. Accordingly, connector “6” 129 is understood to be accessible from one or more of the steps in FIGS. 9-13.

The reference routine enables the user to access reference materials on the computer 3 or similar materials on the internet accessible to the computer 3 via wireless or wire-based connections.

The user could select local resources in step 140 and thereafter provided with a selection of local databases which include money related terms, values, interest rates, investments, and the like in step 141. Alternatively, the user could select internet-based resources in step 142 and thereafter provided with a list of websites in step 143 which are related to money, of interest and benefit to the user, and accessed by the computer 3. Internet selections could include, but not limited to, the FDIC Learning Bank, Federal Reserve Kids Page, Money Central Station, The Time Machine—History of Money, Moneyopolis, OrangeKids.com, and YoungInvestor.com. Upon selection of a resource, web browser software is executed to access, view and facilitate the user's interaction with the internet-based information. The software 100 remains executable separate and apart from the web browser and concurrently functional to the user. Thereafter, the user is queried to perform another activity in step 144 and either referred back to the main screen via the connector “4” 126 or to terminate the virtual teller 49 in step 145 including the steps of closing all programs executed and files opened by the software 100.

The software 100 described in FIGS. 15-22 provide for one possible embodiment of the virtual teller 49. Screens not meant to be exhaustive of the appearance and functionality of the present invention, but rather are merely illustrative to assist in describing aspects of the software 100 and its function in the manner described herein. Screens are compatible with a variety of operating systems including WINDOWS®, Mac OS, LINUX, and the like. Fields, selections, bars, and icons are understood to provide visual references which facilitate execution of task specific routines within the software 100 by the computer 3. The screens are further understood to include visual and audio components of the virtual teller 49 and background 50 described herein. The software 100 could appear as an icon on the desktop or within a folder displayed by the computer and launched by selecting the appropriate icon via a mouse controlled cursor.

Referring now to FIG. 15, an exemplary startup screen 201 is shown including at least an input field 202 and a navigation bar 203. The input field 202 facilitates the entry of user specific information including but not limited to account name and password. This information is used to access one or more files residing on the computer 3 which contain account balance data, transaction history information, planning data, profile data, and user preferences pertaining the functionality and appearance of the virtual teller 49. The navigation bar 203 allows a user to quickly navigate the screens shown in FIGS. 16-22. For example, the BALANCE selection displays FIG. 16 on the computer 3; the DEPOSIT selection displays FIG. 17 on the computer 3; the WITHDRAWAL selection displays FIG. 18 on the computer 3; the PLANNING selection displays FIG. 19 on the computer 3; the PLOTTING selection displays FIG. 20 on the computer 3; the GAMES selection displays FIG. 21 on the computer 3; and the PROFILE selection displays FIG. 22 on the computer 3. The navigation bar 203 is preferred to be displayed on each screen to simplify use of the virtual teller 49.

Referring now to FIG. 16, an exemplary account summary screen 204 is shown including at least an account summary field 205, a selection field 206, and a navigation bar 203. The account summary field 205 provides a quick overview of the identified account including but not limited to a current balance, dates pertaining to last deposit and withdrawal, amount of last withdrawal, and a statement as to the sufficiency of funds saved relative to a savings goal and/or plan. The selection field 206 includes a list of items which are selectable by the user via a mouse controlled cursor or by entering the corresponding number via a keyboard attached to the computer 3. The selected item could display descriptive information pertaining to the selection, a popup input field enabling the entry of a filename or the like, or more details or options consistent with the selection.

Referring now to FIG. 17, an exemplary deposit screen 207 is shown including at least an input field 208 and a navigation bar 203. The input field 208 allows a user to manually enter and/or confirm the total amount of funds deposited into the money storage peripheral 1 in the form of paper currency and coins. A total deposit is calculated by the software 100 and displayed within the input field 208 in real time. Amounts entered and calculated are preferred to be saved to a file within the computer 3 with date information for later retrieval and reference.

Referring now to FIG. 18, an exemplary withdrawal screen 209 is shown including at least an input field 210 and a navigation bar 203. The input field 210 allows a user to manually enter and/or confirm the total amount of funds withdrawn from the money storage peripheral 1. A new balance is calculated by the software 100 and displayed within the input field 210 in real time. The user could also be required to enter her password which is verified by the software 100 prior to dispensing or releasing any funds from the money storage peripheral 1. Also, the user could be required to describe the reason for withdrawal which could be compared to the stated purpose of the savings account. Amounts entered and calculated and reason for the withdrawal are preferred to be saved to a file within the computer 3 with date information for later retrieval and reference.

Referring now to FIG. 19, an exemplary planning screen 211 is shown including a selection field 212 and navigation bar 203. The selection field 212 could include a variety of options which facilitate the launch of screens for the purpose of preparing a savings program specific to a purchase, viewing the status of an account, accessing financial tips, and creating reminders.

The development of a saving plan could include the identification of a savings profile including a cumulative total over a specified time period with milestone goals during the course of the savings period. For example, a user might identify a savings plan for a new bicycle based the deposit of twenty dollars each Friday over a fifteen week period starting on an identified date. The user would then deposit twenty dollars each Friday and the software 100 would track the user's progress. If the user deposit s less than twenty dollars at one time, withdrawal funds, or otherwise have less than the total funds required as of a deposit date, then the software 100 would remind the user during the course of subsequent deposits that additional funds are required to meet the projected completion date. If the user deposits more than twenty dollars at one time, then the software could identify the overage and remind the user to skip or reduce the amount of a subsequent deposit.

The user could also view or track progress during the term of a saving plan. For example, the user might benefit from growth projections based on one or more savings options available at a bank or financial institution. The software 100 could allow the user to identify when all or some of the accumulated funds have been transferred to an account separate from the money storage peripheral 1. The user could project a new purchase schedule based on actual deposits and withdrawals related to the funds within the money storage peripheral 1 and another account. The user could also view or research financial tips stored locally on the computer 3 or remotely retrieved over the internet. The user could also enter reminder dates via the software 100 so that she is prompted to perform a task when the computer 3 is turned ON or when a specific date and/or time occurs.

Referring now to FIG. 20, an exemplary report screen 213 is shown including a plot field 214 and navigation bar 203. The plot field 214 could show one or more plot types, examples including but not limited to line and bar graphs, which summarize the deposit and withdrawal history and resultant fund balance over a specified time period. In other embodiments, the plot field 214 might include a pie chart or other graphical representation consistent with the data.

Referring now to FIG. 21, an exemplary game screen 215 is shown including at least one or more game icons 216. Each game icon 216 would allow the user to launch and play a computer-based game in exchange for the deposit of a specified amount into the money storage peripheral 1. For example, the software 100 could launch a pinball game in exchange for a deposit of fifty cents. The user would be prompted to deposit the funds after selecting the appropriate game icon 216. The money storage peripheral 1 would communicate the deposit of fifty cents to the computer 3 and thereafter the software 100 would launch the execution of the pinball program. In some embodiments, the user might be required to make an additional deposit to continue play after a game is completed. Games could reside locally on and be executable by the computer 3 or reside and be executable over the internet.

Referring now to FIG. 22, an exemplary profile screen 217 is shown including at least an input field 218. The input field 218 could allow the user to enter her name and address, as well as define and confirm a password. Information entered by the user could be saved to a file within the computer 3 with date information for later retrieval and reference.

The description above indicates that a great degree of flexibility is offered in terms of the present invention. Although devices and methods have been described in considerable detail with reference to certain preferred versions thereof, other versions are possible. Therefore, the spirit and scope of the appended claims should not be limited to the description of the preferred versions contained herein.

What is claimed is:

1. A money storage device comprising:
(a) a money storage peripheral capable of receiving, storing, and dispensing money;
(b) a virtual teller which is animated and interacts via audio and visual means with a user in response to cues from said money storage device, said virtual teller enabling said user to enter account information, to track, project, and report savings data, and to access reference and educational materials; and
(c) a communications link either wire-based or wireless between said money storage peripheral and a computer, said virtual teller residing on said computer separate from said money storage peripheral.

2. The money storage device of claim 1, wherein said money storage peripheral includes a coin receptacle and a paper money receptacle with real time counting functionality.

3. The money storage device of claim 1, wherein said money storage peripheral includes a keypad and a display.

4. The money storage device of claim 1, wherein said communications link is a USB interface.

5. The money storage device of claim 1, wherein said communication link is an RF interface, WIFI interface, optical interface, or a BLUETOOTH interface.

6. The money storage device of claim 1, wherein said computer is a laptop computer or a desktop computer.

7. The money storage device of claim 1, wherein said virtual teller is a real person who speaks, commands, and responds to said user during a banking transaction.

8. The money storage device of claim 1, wherein said virtual teller is a character who speaks, commands, and responds to said user during a banking transaction.

9. The money storage device of claim 1, wherein said virtual teller communicates an audio greeting and/or a visual greeting to said user.

10. The money storage device of claim 1, wherein said virtual teller prompts said user visually and/or audibly for an access code.

11. The money storage device of claim 1, wherein said virtual teller includes at least one game playable by said user after deposit of a coin or a paper money into said money storage peripheral.

12. The money storage device of claim 1, wherein said money storage peripheral has a lock mechanism which is mechanically or electrically operable to prevent unauthorized access to funds within said money storage peripheral.

13. A method of using a money storage device comprising the steps of:
(a) displaying a virtual teller via a software program residing on a locally-based computer attached to a money storage peripheral via a communications link, said virtual teller being animated and interacting via audio and visual means with a user in response to cues from said money storage device, said virtual teller enabling said user to enter account information, to track, project, and report savings data, and to access reference and educational materials, said virtual teller teaches said user to be financially sophisticated regarding the saving, budgeting, and investing of money via a fun, non-threatening, and engaging format; and
(b) facilitating a money transaction between said user and said money storage peripheral via said virtual teller.

14. The method of claim 13, wherein said facilitating step includes depositing money into said money storage peripheral.

15. The method of claim 13, wherein said facilitating step includes withdrawing money from said money storage peripheral.

16. The method of claim 13, wherein said virtual teller is a real person who speaks, commands, and responds to said user during said money transaction.

17. The method of claim 13, wherein said virtual teller is a character who speaks, commands, and responds to said user during said money transaction.

18. The method of claim 13, further comprising the step of:
(c) projecting the future value of an account via said virtual teller.

19. The method of claim 13, further comprising the step of:
(c) developing a savings plan via said virtual teller.

20. The method of claim 13, further comprising the step of:
(c) researching financial resources via said virtual teller.

21. The method of claim 13, further comprising the step of:
(c) enabling said user to play a game via said virtual teller after making a deposit.
